(19) United States
(12) Patent Application Publication
(10) Pub. No.: US 2022/0141226 A1
(43) Pub. Date: May 5, 2022

(54) Anti-phishing apparatus and method

(71) Applicant: Uniregistry Corp., Grand Cayman (KY)

(72) Inventors: Francisco José OBISPO SEMIDEY, Aliso Viejo, CA (US); Luis Enrique MUNOZ RODRIGUEZ, Newport Beach, CA (US); Ernesto Miguel HERNANDEZ-NOVICH, Newport Beach, CA (US); Luis Roberto GONZALEZ, Long Beach, CA (US)

(21) Appl. No.: 17/310,734

(22) PCT Filed: Mar. 27, 2020
(86) PCT No.: PCT/IB2020/052972

§ 371 Date: Aug. 20, 2021

Related U.S. Application Data
(60) Provisional application No. 62/825,015, filed on Mar. 27, 2019.
(60) Provisional application No. 62/704,063, filed on Mar. 30, 2019.

(51) Int. Cl. H04L 9/40; H04L 61/3015; G06F 40/295

(52) U.S. Cl. CPC H04L 63/101; H04L 63/1483; G06F 40/295; H04L 61/302

(57) ABSTRACT

Apparatus and methods are described in which a namespace is protected against misleading registration of names within the namespace. A list of canonically expressed text strings is maintained. A concordancer is defined, which concordancer may be updated from time to time as, for example, characters are added to a permitted character set for the namespace. When a first user attempts to register a proposed name within the namespace, the proposed name is subjected to an attempted match to each of the outputs of the concordancer with respect to each of the canonically expressed text strings on the list. In the event of a match, the attempted registration is not permitted to proceed. The protection may be implemented simultaneously across multiple namespaces, each having its own respective concordancer.

### BACKGROUND

The invention directs itself generally to the problems of scamming and spearphishing. Scammers and spearphishers send misleading messages to human users, hoping to trick a human user into some unwise action such as clicking on a link or typing in a password or visiting a web site or installing an app. The trick might be a “man in the middle” attack in which the spearphisher presents a fake but convincing screen that looks like a login screen for a bank or social media account. The unwise human user might get tricked into typing his or her password into the login screen. Such spearphishing attempts, when successful, have led to unfortunate outcomes such as purloining of bitcoin, stealing of money, and appropriation of a person's social media account. Depending upon the nature of the user interface involved, part of the fake but convincing screen may be a URL (uniform resource locator) or a fully qualified domain name (FQDN) or a web link or some other type of clickable link in a message or display screen, or an entry in the “location bar” of a web browser.

Another somewhat related problem is the use of a deceptive name in a namespace, the name being deceptively similar to a trademark. The use of the deceptive name can lead to confusion in the mind of a consumer to the source of goods or services.

One example of a namespace in which such problems arise is that of Internet domain names. A commonly presented problem is the registration of a so-called “second level domain name” within a namespace defined by a so-called “top-level domain”. The term namespace means, for example, internet top-level domain names, user identifiers, social media handles, and other distinct or unique identifiers for various applications. These terms may be used interchangeably throughout the application. It should be appreciated that while exemplary embodiments of the invention describe the interworkings between internet top-level domain names, registries, registrars and consumers, the same principles may be applied in various other applications by alert persons for assignation of user identifiers, social media handles (such as Twitter) and other distinct or unique identifiers.

Trademark owners and financial services providers are among the entities that often feel the need to try to reduce the opportunities for bad people to pursue such scamming and spearphishing, and to reduce the opportunities to carry out activities that constitute trademark infringement or trademark dilution or unfair competition. Such entities, for sake of convenient reference referred herein to as “rights holders”, pursue many strategies toward these ends, including the use of judicial remedies and domain name dispute proceedings.

Historically, one of the protective approaches pursued by a rights holder is an attempt to register in advance some of the names in a namespace that would be attractive to a bad person. If a bank's name is “South Bank” the bank might for example register some Internet domain name for its own active use such as “south-bank.com” but might also attempt to register variants thereof, such as “southbank.com” without the hyphen, and maybe “s0uthbank.com” where the “o” has been replaced with the numerical 0 and maybe “5outhbank.com” where the “s” has been replaced with a numerical digit 5.

One problem with the registering-in-advance approach is that no matter how creative and thoughtful the rights holder may be, the rights holder may fail to think of all of the confusingly similar variants that are candidates for such protective registration. The alert reader will realize that the number of variants can be overwhelming.

Another problem with the registering-in-advance approach is that as time passes, the permitted characters within the namespace may get augmented, and a consequence may be that a new opportunity comes into existence for registration of a confusingly similar name, a new opportunity that is not appreciated by the rights holder until it is too late. As a simple example, suppose that in some namespace what gets added to the set of permitted characters is an “em dash” which looks a lot like a hyphen. The rights holder might realize the need to register the name that makes use of the em-dash only after a bad person has already registered it.

Another problem with the registering-in-advance approach, depending on the namespace involved, is that it may prove to be expensive, perhaps prohibitively expensive, to carry out the protection using registration of names. In a typical Internet top-level domain (“TLD”), annual fees for registration of a second-level domain name will be at least single digits of dollars.

A still more subtle problem with the registering-in-advance approach is that the platform by which a potentially deceived user interacts with the namespace may evolve with time. Consider, say, a web browser. The potentially deceived user may view a web page in the web browser, and the web page may contain a link created by a bad person. Heretofore the link might have been a link containing sufficient visual cues that the alert user would have a chance to detect that the link is deceptive. But imagine that over time, a web browser might come to be more and more feature-rich, the richness for example permitting a web designer to specify a new font that is to be used for rendering of the web page. What might then happen is that the new font permits the bad person to make use of some substituted character that is much more difficult to detect (visually) in that new font. So to use our “South Bank” example, imagine that the bad person hopes to use a Greek letter “mu” μ as a substitute for the letter “u” in “South”. In our hypothetical example, heretofore the range of available fonts was such that the alert user could have a good chance to detect the substituted μ. But in our hypothetical example, perhaps a new font becomes available in which many letters have descenders or serifs and the “u” and the “μ” no longer look very different. In such an environment, the rights holder could perhaps be forgiven for failing to identify instantly the need to register yet another name in the namespace.

Some historical approaches to try to address these issues include the use of a “sunrise” period in the introduction of a new namespace. For example if a new TLD is announced, perhaps there will be a sunrise period during which rights holders have a first opportunity to register particular domain names in that TLD based upon a goal of preventing bad people from registering them. It will be appreciated, however, that a sunrise period is typically based on the exact form of a trademark and is of no help at all in addressing the event of a usual character permutation such as 5outhbank or S0uthbank, or a character set in a namespace being augmented at some later time, perhaps years after the initial launch of the TLD. It will likewise be appreciated that a sunrise period is no help at all in addressing the usage of fonts that can make two different characters look confusingly similar, which could happen years after a sunrise period.

Sunrise is by definition a thing that happens at most once per TLD. By definition, it is not possible to have a “permanent sunrise”.

Imagine the case where a first bad person registered a confusingly similar name in a namespace, and then permitted the registration to lapse. Of course, from the point of view of the rights holder it would be desirable to prevent a second bad person from registering that same name now that it is back in the pool of available names in the namespace. The registering-in-advance approach would only help with prevention of such events if the rights holder were constantly monitoring all such lapses, poised at all times ready to pounce on the newly available name. For most rights holders in most namespaces, this is just not a realistic goal.

One attempt to address somewhat similar problems is described in US patent publication number US 2014/0283106 A1, published Sep. 18, 2014 and entitled Domain protected marks list based techniques for managing domain name registrations. See also US patent publication number US 2002/0099693 A1, published Jul. 25, 2002 and entitled Method and apparatus for performing automated trademark and domain name correlation. See also US patent publication number US 2004/0220903 A1, published Nov. 4, 2004 and entitled Method and system to correlate trademark data to internet domain name data. See also US patent publication number US 2019/0384859 A1, published Dec. 19, 2019 and entitled Collectively performing domain searches and trademark searches. See also US patent publication number US 2020/0034398 A1, published Jan. 30, 2020 and entitled Methods and systems for recommending packages of domain names for registration. See also US patent publication number US 20150100507 A1, published Apr. 9, 2015 and entitled Domain protected marks list service.

The alert reader will appreciate that there is a great need for a dynamic protection approach in a namespace that is able to respond to changing conditions even after a “sunrise” period has passed, or avoiding risks of domains lapsing. There is a great need for a protection approach in a namespace that is able to respond to a lapse in a registration of a confusingly similar name in that namespace. There is a great need for a protection approach in a namespace that is able to respond to augmentation of permitted character sets in that namespace. There is a great need for a protection approach in a namespace that is able to respond to user interface changes such as feature enhancements and font enhancements in browsers. From the above discussion it will also be appreciated that attempting to protect a text string by registering each and every possible name in the namespace would have some important and hard-to-cap recurring costs and it may be desirable to have an approach with a smaller recurring cost.

### SUMMARY OF THE INVENTION

Apparatus and methods are described in which a namespace is protected against misleading registration of names within the namespace. A list of canonically expressed text strings is maintained. A concordancer is defined, which concordancer may be updated from time to time as, for example, characters are added to a permitted character set for the namespace. When a first user attempts to register a proposed name within the namespace, the proposed name is subjected to an attempted match to each of the outputs of the concordancer with respect to each of the canonically expressed text strings on the list. In the event of a match, the attempted registration is not permitted to proceed. The protection may be implemented simultaneously across multiple namespaces, each having its own respective concordancer, or sharing the same concordancer as the case may be. The namespace may be administered by a wholesale entity which in turn has relationships with a plurality of retail entities, and the entity to which the first user presents the attempted registration may be one of the retail entities. A text string may get added to the list by means of a request received by a first one of the retail entities from a second user, the status of the presence of the text string on the list being an association tied to the second user, and a mechanism may be set up by which such an association may be transferred by the second user from a first one of the retail entities to a second one of the retail entities. The namespaces may be Internet domain names, and the text strings may be trademarks.

### DESCRIPTION OF THE DRAWING

The invention will be described with respect to a drawing in several figures, of which:

FIG. 1 shows a first aspect of the invention in functional block diagram form;

FIG. 2 shows a second aspect of the invention in functional block diagram form;

FIG. 3 shows a third aspect of the invention in functional block diagram form;

FIG. 4 shows a system diagram with exemplary hardware;

FIG. 5 shows exemplary confusable variants of a protected text string; and

FIG. 6 shows a specific example of ways that fonts can lead to confusion.

### DETAILED DESCRIPTION

U.S. patent application No. 62/825,015 filed 27 Mar. 2019 and U.S. patent application No. 62/704,063 filed 30 Mar. 2019 are incorporated herein by reference for all purposes.

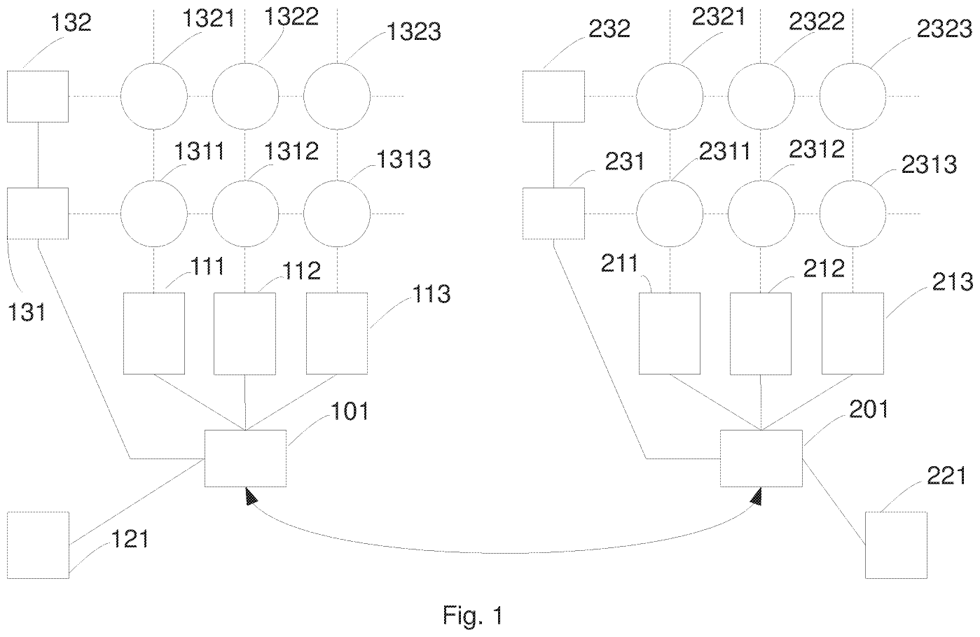

A first aspect of the invention has to do with coordination among wholesalers or database operators or domain name registries. This first aspect of the invention will be described using terminology from ecosystems of domain name registries and domain name registrars and top-level domains, but the alert reader will appreciate that the teachings of this first aspect of the invention are not at all limited to domain name ecosystems but are very much applicable to any outward-facing interface to a social media ecosystem and are very much applicable to any DNS-like system of propagated lookups. We can speak generally of namespaces, meaning, for example, internet top-level domain names, user identifiers, social media handles (such as Twitter's), and other distinct or unique identifiers for various applications. For this first aspect of the invention we turn to FIG. 1.

FIG. 1 shows a domain name registry 101. The domain name registry 101 is charged with providing a fundamental database (or group of related databases) defining registrations by which parties have some predefined registration right such as a domain name registration in TLDs (top-level domains) 131, 132. This charge is depicted in the solid line connecting registry 101 with TLDs 131, 132.

In a typical TLD ecosystem, it is designed into the ecosystem that the registry 101 does not have direct contact with consumers (omitted for clarity in FIG. 1). The ecosystem is designed such that a particular consumer registers a domain name in a TLD 132 by initiating contact with one registrar 111 among several registrars 112, 113. The registrar 111 in turn communicates with the registry 101.

What happens perhaps hundreds or thousands of times per day is a consumer registering a domain name in a TLD 132 by initiating contact with a registrar 111 which in turn communicates with the registry 101. Typical steps include:
Consumer devises a domain name that it wishes to try to register within the TLD 132.
Consumer looks up the candidate domain name in a lookup user interface and learns whether or not the domain name is “available”.
If the domain name is “available”, the consumer clicks something in a user interface with the registrar 111 to make payment arrangements and to provide other required information such as contact information. Without delay registrar 111 does a handshake with registry 101 giving rise to an ephemeral “lock” on the to-be-registered domain name.
The ephemeral lock serves to block attempted registrations of that domain name by other consumers through other registrars 112, 113.
The ephemeral lock would likewise serve to block an attempted registration of that domain name by some second consumer through registrar 111, although of course one hopes that the registrar 111 would have designed its own systems to block such attempts by a second consumer by means of an ephemeral lock that is local to registrar 111's own systems.
Additional exchanges take place between registrar 111 and registry 101 to finalize the registration of the domain name. In the world of DNS this includes defining nameservers for the domain name. Among other things the registry 101 directly or indirectly administers a DNS zone file for the TLD that returns nameserver records as needed for DNS resolution to succeed. For any given TLD 132 there is usually defined a “whois” resource and typically registry 101 directly or indirectly administers a database that defines lookup results in that “whois” resource.
Money gets paid from the consumer to the registrar 111. Money gets paid from the registrar 111 to the registry 101.

There is thus a point of intersection 1321 which denotes the fact that the domain name that just got registered came to be registered in TLD 132 by means of a consumer interaction with a registrar 111.

The majority of the time, the point of intersection 1321 remains static for the lifetime of the domain name registration. But what may happen from time to time is that the registrant for the domain name might decide to transfer the domain name from registrar 111 to (say) registrar 112. The transfer of the domain name takes places through a fairly complex sequence of handshakes and record locks and database updates. The transfer sequence needs to satisfy several requirements:
The consumer needs to be able to carry out the tasks in a predictable way with a very high expectation that the transfer, if proper, will succeed.
The transfer needs to avoid accidental surrender of the domain name into the pool of available domain names such that a third party could grab the domain name.
The transfer needs to be secure against purloining of the domain name, meaning that the system needs to guard against the risk that someone would masquerade as the registrant and steal the registration.
The transfer needs to be quick, with no greater latency than is absolutely needed.
Underlying metadata such as nameserver and contact information need to be passed along as necessary to the gaining registrar 112.

In many TLD ecosystems, it is a design goal that the registry 101 does the absolute minimum needed for the system to work, and that to the extent any other functions or tasks exceed that absolute minimum, the functions and tasks are imposed upon the registrar 111. It is a further design goal in many ecosystems that the registry 101 carry out its work at a very low cost per domain name per year. A comparison can be made to the regulated utility such as an electric company or gas company that enjoys a natural monopoly in its service area, and the monopoly work is kept at a regulated price by a regulatory agency. In such a TLD ecosystem, the registrars 111, 112, 113 each select what could be called a respective retail markup relative to a wholesale price from the registry 101. The registrars 111, 112, 113 each choose for themselves a level of customer support and a mix of services, thus competing with each other on price as well as on other aspects of a consumer experience.

From time to time a new TLD or group of TLDs 231, 232 will be created, and the group of TLDs is administered by a registry 201 that is not the same as registry 101. Registrars 211, 212, 213 stand in a retail relationship with consumers and communicate in a wholesale way with registry 201. In FIG. 1, for simplicity of presentation and visual portrayal, registrars 211, 212, 213 are depicted as distinct from registrars 111, 112, 113. The alert reader appreciates, however, that a frequently observed real-life situation is that a particular consumer-facing retail company will often choose to have a registrar relationship 113 with registry 101 (thus being able to sell domain names 131, 132) and will also choose to have a registrar relationship 213 with registry 201 (thus being able to sell domain names 231, 232). The fact of some companies serving in such dual registrar roles is omitted from portrayal in FIG. 1 for clarity.

The discussion of the preceding six paragraphs is extremely familiar to many alert readers, and serves as background for the above-mentioned first aspect of the invention which will now be discussed. In this aspect of the invention, a first registry 101 administers a blocking system 121. Each namespace (here, a TLD such as TLD 131 or TLD 132) is protected against misleading registration of names within the namespace. A list of canonically expressed text strings is maintained within the blocking system 121. A concordancer is defined, which concordancer may be updated from time to time as, for example, characters are added to a permitted character set for the namespace. Each TLD 131 or 132 has an associated concordancer. When a first user attempts to register a proposed name within for example TLD 132, the proposed name is subjected to an attempted match to each of the outputs of the concordancer with respect to each of the canonically expressed text strings on the list stored in the blocking system 121. In the event of a match, the attempted registration is not permitted to proceed. The protection may be implemented simultaneously across multiple TLDs for example TLD 131 in addition to TLD 132, each TLD having its own respective concordancer. The namespace (here, TLD 132 for example) may be administered by a wholesale entity 101 which in turn has relationships with a plurality of retail entities 111, 112, 113, and the entity to which the first user presents the attempted registration may be one of the retail entities such as registry 111.

The alert reader notes that the entire right-hand portion of FIG. 1 now benefits from discussion. What happens for example is that a member of the public might try to register a domain name in one of the TLDs 232, 231 for example TLD 232. The member of the public does so by approaching one of the registrars 211, 212, 213 for example registrar 211. The request to register the domain name in TLD 232 gets communicated through registrar 211 to registry 201.

What is described herein is that registry 201 chooses to coordinate with registry 101 in a sophisticated way. Registry 201 has a blocking system 221 that is analogous to the blocking system 121 of registry 101. When a request regarding a proposed registration in TLD 232 arrives at registry 201 for example from at registrar 211 from the would-be registrant, the concordancer that is defined for TLD 232 is put to use against the list of protected canonically expressed text strings from blocking system blocking system 221. If the proposed registration is a match to one of the outputs of the concordancer, then the attempted registration in the TLD 232 is blocked.

The alert reader will appreciate that such coordination between registries leads to an extremely helpful outcome for the entity seeking to protect a string such as a trademark from unauthorized registration across the shared namespaces of all participating registries. By cleverly orchestrating the operation of the respective concordancers, protection can extend beyond the usage of labels that are identical to the trademark, into labels that look confusingly similar by virtue of the rendering of combinations of international symbols, to the original trademark. The outcome can be that registration of a confusingly similar domain name in TLD 132 can blocked because of the direct activities of registry 101, but importantly also can be that registration of a confusingly similar domain name in TLD 232 can likewise blocked because of the direct activities of registry 102, in coordination with registry 101.

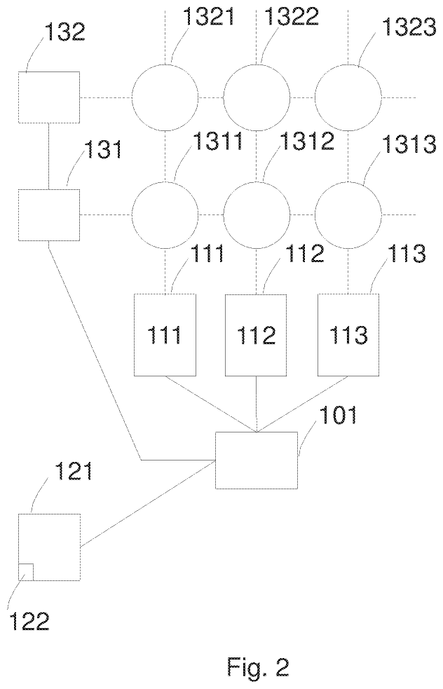

A second aspect of the invention has to do with coordination among retailers (for example domain name registrars). This second aspect of the invention will be described using terminology from ecosystems of domain name registries and domain name registrars and top-level domains, but the alert reader will appreciate that the teachings of this second aspect of the invention are not at all limited to domain name ecosystems but are very much applicable to any outward-facing interface to a social media ecosystem and are very much applicable to any DNS-like system of propagated lookups. For this first aspect of the invention we turn to FIG. 2.

FIG. 2 shows a domain name registry 101. The domain name registry 101 is charged with providing a fundamental database (or group of related databases) defining registrations by which parties have some predefined registration right in TLDs (top-level domains) 131, 132. This charge is depicted in the solid line connecting registry 101 with TLDs 131, 132.

In a typical TLD ecosystem, it is designed into the ecosystem that the registry 101 does not have much direct contact with consumers (omitted for clarity in FIG. 2). The ecosystem is designed such that a particular consumer registers a domain name in a TLD 132 by initiating contact with one registrar 111 among several registrars 112, 113. The registrar 111 in turn communicates with the registry 101.

As was discussed above, what happens perhaps hundreds or thousands of times per day is a consumer registering a domain name in a TLD 132 by initiating contact with a registrar 111 which in turn communicates with the registry 101. The typical steps are described above. There is thus a point of intersection 1321 which denotes the fact that the domain name that just got registered came to be registered in TLD 132 by means of a consumer interaction with a registrar 111. As mentioned above, the majority of the time, the point of intersection 1321 remains static for the lifetime of the domain name registration. But what may happen from time to time is that the registrant for the domain name might decide to transfer the domain name from registrar 111 to (say) registrar 112. The transfer of the domain name takes places through a fairly complex sequence of handshakes and record locks and database updates. The transfer sequence needs to satisfy requirements discussed above. As was mentioned above, in such a TLD ecosystem, the registrars 111, 112, 113 each select what could be called a respective retail markup relative to a wholesale price from the registry 101. The registrars 111, 112, 113 each choose for themselves a level of customer support and a mix of services, thus competing with each other on price as well as on other aspects of a consumer experience.

We now turn to a second aspect of the invention which will now be discussed. In this aspect of the invention, a registry 101 administers a blocking system 121. Each namespace (here, a TLD such as TLD 131 or TLD 132) is protected against misleading registration of names within the namespace. A list of canonically expressed text strings is maintained within the blocking system 121. A concordancer is defined, which concordancer may be updated from time to time as, for example, characters are added to a permitted character set for the namespace. Each TLD 131 or 132 has an associated concordancer. When a first user attempts to register a proposed name within for example TLD 132, the proposed name is subjected to an attempted match to each of the outputs of the concordancer with respect to each of the canonically expressed text strings on the list stored in the blocking system 121. In the event of a match, the attempted registration is not permitted to proceed. The protection may be implemented simultaneously across multiple TLDs for example TLD 131 in addition to TLD 132, each TLD having its own respective concordancer. The namespace (here, TLD 132 for example) is administered by a wholesale entity 101 which in turn has relationships with a plurality of retail entities 111, 112, 113, and the entity to which the first user presents the attempted registration may be one of the retail entities such as registrar 111.

The natural questions that arise include such questions as how an item finds its way into the list of canonically expressed text strings. A text string may get added to the list in the blocking system 121 by means of a request received by a first one of the retail entities 113 from a second user, the status of the presence of the text string on the list being an association tied to the second user, and a mechanism may be set up by which such an association may be transferred by the second user from a first one of the retail entities to a second one of the retail entities. The namespaces may be Internet domain names, and the text strings may be trademarks.

In a typical arrangement what happens is that a party desiring to obtain protection approaches one of the registrars 111, 112, 113, for example registrar 113. The party desiring such protection is in a typical case a trademark owner or some other entity such as a financial institution wishing to guard against fraudulent activity. The party approaches registrar 113 and presents a text string of interest. The text string is expressed in a canonical form and is stored in a database in the blocking system 121. This gives rise to successful blocking as described above in connection with the first aspect of the invention.

What can now be appreciated is that according to this aspect of the invention, a database 122 keeps track of the particular registrar 113 that gave rise to this item in the list of canonically expressed text strings. At a later time, the party that obtained the protection might make a business decision to change to a different registrar (say, registrar 112) for its protection relationship going forward. Such a decision might be prompted by any of a number of business factors including price, quality of service, or a simple desire to consolidate several such protections with a single registrar.

The transfer is preferably carried out in a way that is in some ways similar to the way that a domain name can be transferred from one registrar to another. The transfer of the domain name takes places through a sequence of steps leading to a database update. The transfer sequence needs to satisfy several requirements:
The consumer needs to be able to carry out the transfer in a predictable way with a very high expectation that the transfer, if proper, will succeed.
The transfer needs to avoid accidental loss of the protection for any non-negligible period of time.
The transfer needs to be secure against purloining of the protection, meaning that the system needs to guard against the risk that someone would masquerade as the owner of the protection and steal the protection.
The transfer needs to be quick, with no greater latency than is absolutely needed.

Underlying metadata such as the contact information need to be passed along as necessary to the gaining registrar 112.

We can describe the situation thusly—this implementation empowers the Domain Name Registrant (who is often the a trademark owner) in that it considers the blocking mechanism on a particular string as a portable object: the object can be created at the request of the domain name registrant by its Registrar of choice, and then be transferred and managed by another Registrar, at the Registrant's discretion. The object can also be registered for a number of years at creation time (from 1 to 10 years) and can be renewed at the end of the registration time. It can of course be deleted at the Registrant's request through the acting Registrar. This makes such a blocking service easy to use because it mimics what a portfolio manager or trademark holder would typically do with an actual domain name and it can be managed accordingly.

It is appreciated that what is described here is a system that is platform agnostic. It works well regardless of the details of the underlying registry platform.

A third aspect of the invention has to do with selective handling of one or another of the variants of a protected text string. With the abundance of top-level domains nowadays, a trademark holder may decide to block a particular domain name one day, but realize they need it for a different project years later. This gives rise to what might be called an unblocking feature. With this feature, the holder of the block can decide to unblock one specific combination of the protected string and a top-level domain for their own use, at any date. In other words, the trademark holder could decide to use Trademark.click while Trademark.link and Trademàrk.photo do remain blocked. Only the trademark holder, or the holder of an identical trademark, could successfully ask for the unblocking. The unblocking request is verified by their Registrar and by the Registry providing the service, to make sure that the unblocking cannot be used by a nefarious third party.

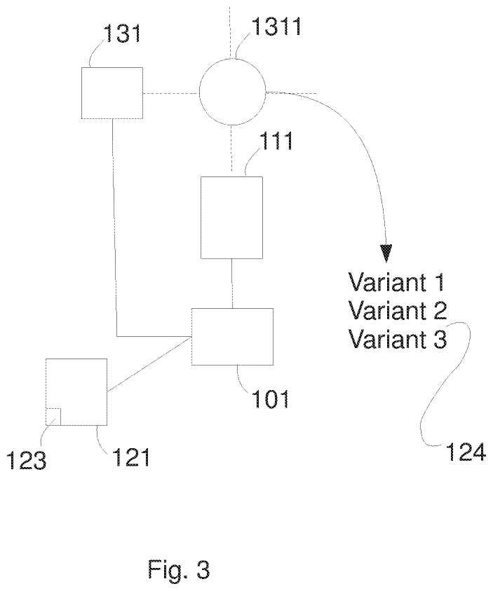

Once again, we describe the aspect of the invention using terminology from ecosystems of domain name registries and domain name registrars and top-level domains, but the alert reader will appreciate that the teachings of this third aspect of the invention are not at all limited to domain name ecosystems but are very much applicable to any outward-facing interface to a social media ecosystem and are very much applicable to any DNS-like system of propagated lookups. For this first aspect of the invention we turn to FIG. 3.

FIG. 3 shows a domain name registry 101. The domain name registry 101 is charged with providing a fundamental database (or group of related databases) defining registrations by which parties have some predefined registration right in TLD (top-level domains) 131. This charge is depicted in the solid line connecting registry 101 with TLD 131.

As was discussed above, what happens perhaps hundreds or thousands of times per day is a consumer (omitted for clarity in FIG. 3) registering a domain name in a TLD 131 by initiating contact with a registrar 111 which in turn communicates with the registry 101. The typical steps are described above.

Once again in connection with FIG. 3 a registry 101 administers a blocking system 121. Each namespace (here, a TLD such as TLD 131) is protected against misleading registration of blocked names within the namespace. A list of canonically expressed text strings is maintained within the blocking system 121. A concordancer is defined, which concordancer may be updated from time to time as, for example, characters are added to a permitted character set for the namespace. Each TLD 131 has an associated concordancer. When a first user attempts to register a proposed name within for example TLD 131, the proposed name is subjected to an attempted match to each of the outputs of the concordancer with respect to each of the canonically expressed text strings on the list stored in the blocking system 121. In the event of a match, the attempted registration is not permitted to proceed. The namespace (here, TLD 131 for example) is administered by a wholesale entity 101 (in this context, a registry) which in turn has relationships with a plurality of retail entities (registrars in this context) 111, and the entity to which the first user presents the attempted registration may be one of the retail entities such as registrar 111.

The owner of the block for a particular item in the list of canonically expressed text strings might wish to selectively permit some other party (typically a party with which it is on pleasant terms) to register a domain name that would normally be blocked.

As a second example, the owner of the block might wish itself to have the flexibility to register a particular one of the domain names that would normally be blocked.

What can now be appreciated is that according to this aspect of the invention, a database 123 is maintained to store any particular domain names that the block owner wishes to unblock. Suppose the owner of the block wishes to make a particular “variant3” 124 of the string available to another party. The owner can carry out an interaction with the registrar 111 that identifies the domain name and TLD, and that gives rise to an authorization code indicative of the desired unblocking. The particulars of this interaction lead to appropriate records being stored in database 123.

The owner of the block then provides the authorization code to the party.

The party then goes to one of the registrars 111. It will be appreciated that this would not need to be the same registrar as the block owner is using to maintain the block. The party provides the authorization code, and is thus permitted to register the domain name of interest.

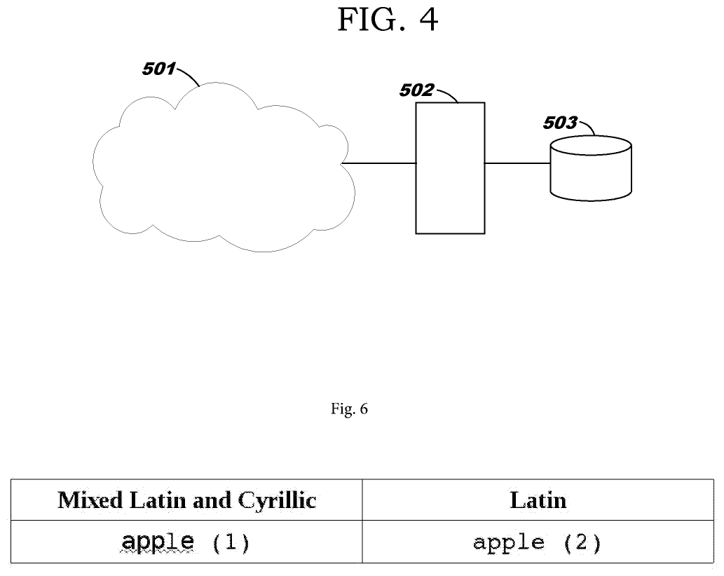

FIG. 4 shows exemplary hardware which may be employed to carry out the invention. For clarity the hardware is depicted with a processor 502, storage 503, and so on, connected to the Internet 501. Real-life considerations will likely prompt a system designer to implement a more complicated hardware environment. For example the designer will place a firewall (or, more likely multiple levels of protection) between the registry system and the Internet. Nonetheless the general concept is that most of the hardware will usually be selected from general-purpose processors running suitable software, connected with data storage devices such as disk drives or solid-state storage, along with suitable routers, switches, firewalls, and the like.

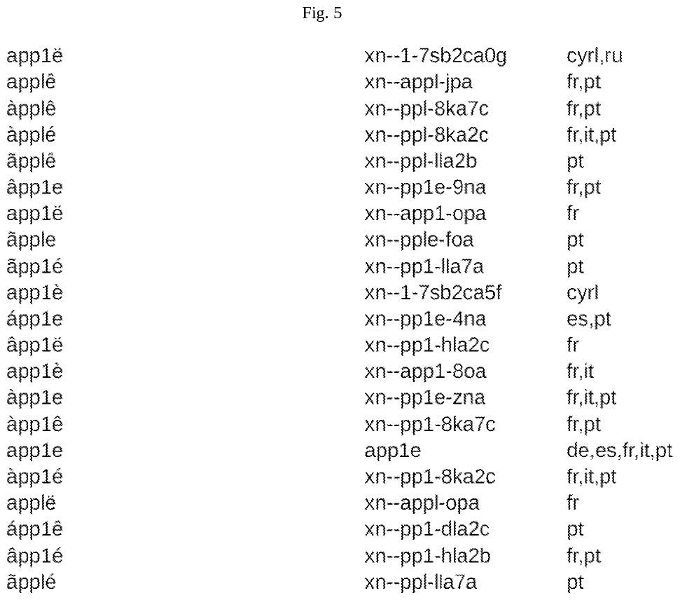

FIG. 5 shows labels that can be easily confused with “apple”. The first column shows the appearance it would have when using letters from other languages, such as “a” and “p” from Cyrillic, as per the last column. The center column shows the internal representation as a Domain Label, where differences become evident.

FIG. 6 is a specific example of a way that fonts can lead to confusion. String (1) has “a”, “p”, and “e” written using Cyrillic glyphs. It is very easy, even for the alert reader, to mistake this representation for string (2), the legitimate one. Such a risk is particularly great if the typeface does not make the difference visually explicit.

From the preceding discussion it will be appreciated that the system described herein offers a great advantage over known systems from the past. With the system described herein, what will happen from time to time is that the system will iterate through each of the items in the list of canonically expressed names in the namespace, and will apply the concordance to the item and generate a first set of to-be-blocked names in the namespace. At some later time, the concordance is augmented, for example because of an expansion in the set of Unicode confusable characters. After that, the system will iterate yet again through each of the items in the list of canonically expressed names in the namespace, and will apply the concordance to the item and generate a second set of to-be-blocked names in the namespace. The alert reader will appreciate that from time to time what will happen is that the second set of to-be-blocked names in the namespace will contain at least one to-be-blocked name in the namespace that was not in the first set of to-be-blocked names in the namespace. In practical terms this can mean that a requested registration can get blocked even though it would not have been blocked at some earlier time, before the augmentation of the concordance.

US patent publication number US 2014/0283106 A1, published Sep. 18, 2014 and entitled Domain protected marks list based techniques for managing domain name registrations was mentioned above. In distinction from that publication, the present discussion describes for example a mechanism for the registrar to manage the block. The present discussion describes a mechanism to release a name currently protected by a block, giving the customer an unprecedented control over the use of its brand. The present discussion describes a way in which one registry can partner with other registry operators to include more TLDs as part of the Block offering by decoupling the two major components of the system, providing a lightweight enforcement mechanism to the registry operator irrespective of the backend system their Registry operates on, to be used during availability checks, infos, and registration paths.

US patent publication number US 2002/0099693 A1, published Jul. 25, 2002 and entitled Method and apparatus for performing automated trademark and domain name correlation was mentioned above. At the time addressed by this document, the number of TLDs was modest and the chief problem needing to be addressed was cybersquatting. The document describes an effort, at the time of registration or possible registration of a particular domain name, to search some trademark databases see if the string of characters typed by the user matched a trademark and/or if the string could be registered as a domain name in the few extensions available. The background for the present invention is that one has a goal of preventing domains from being registered. A list of strings to block is automatically derived from one registered trademark, without the need for any user input. Lastly, the user does not need to choose in which extension they want to block the trademark; all the extensions that are part of the service are automatically considered.

US patent publication number US 2004/0220903 A1, published Nov. 4, 2004 and entitled Method and system to correlate trademark data to internet domain name data was mentioned above. The publication describes an approach in which the system looks for all the trademarks owned by a trademark holder and checks if those strings would be available for registration as domain names. With the present discussion the trademark holder indicates which trademark it wants to use in the system. The system creates a list of strings to be blocked from registration. This is quite different from automatically registering such domain names, as suggested by the publication. In the present discussion, the process automatically creates new strings that should be blocked.

US patent publication number US 2019/0384859 A1, published Dec. 19, 2019 and entitled Collectively performing domain searches and trademark searches was mentioned above. This publication describes a search tool which leads to a registration. In contrast in the present discussion there is no search (the string to be blocked is defined by a user of the blocking system who submits their trademark or other text string to be protected), there is no registration (merely a block), and there is no choice of blocks (all applicable strings are blocked automatically).

US patent publication number US 2020/0034398 A1, published Jan. 30, 2020 and entitled Methods and systems for recommending packages of domain names for registration was mentioned above. This publication discusses the analysis of keywords and offers potential domain name registrations. As an example, the keyword “photography” might generate suggestions such as “Carl.photo” and “Carl.Pics”. The publication suggests for example that a keyword be analysed to generate a different string, whereas in the present discussion the source is the trademark and the system limits itself to character similarities (O and 0) instead of using any kind of lexicon. Moreover, the publication leaves the user the choice to register or not and leaves it to the user the choice of what to register. (In the present discussion what is described is a block meaning that no domain name gets registered.) What's more, the blocked string is automatically defined and is not left to the user's input.

US patent publication number US 20150100507 A1, published Apr. 9, 2015 and entitled Domain protected marks list service was mentioned above. One distinction in the present discussion is that the present system may block variations of a string, variations that are automatically generated.

Although the invention has been described using the particular examples given here, the alert reader will have no difficulty devising numerous obvious variants and improvements, all of which are intended to be covered by the claims which follow.

1. A method for use with a first registry with respect to a first namespace, and for use with a second registry with respect to a second namespace, the first and second namespaces being non-identical, the method carried out with respect to a first blocking system administered by the first registry, the first blocking system containing a first list of canonically expressed names in the first namespace, the first blocking system disposed to make use of a first concordance defined with respect to the first namespace for blocking registrations of names in the first namespace based upon the event of an output of the first concordance with respect to a name in the list in the first blocking system matching a name proposed for registration in the first namespace,
the method carried out with respect to a second blocking system administered by the second registry, the second registry being non-identical to the first registry, the second blocking system containing a second list of canonically expressed names in the second namespace, the second blocking system disposed to make use of a second concordance defined with respect to the second namespace for blocking registrations of names in the second namespace based upon the event of an output of the second concordance with respect to a name in the list in the second blocking system matching a name proposed for registration in the second namespace,
the method comprising the steps of:
periodically replicating the list of canonically expressed names in the first blocking system into the second blocking system, and
periodically replicating the list of canonically expressed names in the second blocking system into the first blocking system.

2. The method of claim 1 further comprising the steps of:
receiving a request for registration of a domain name in the second namespace from a registrar associated with the second registry, and
blocking the registration thereof based upon an entry in the blocking system of the first registry; and
annunciating the blocking to a human user.

3. The method of claim 1 wherein each namespace is an internet top-level domain.

4. The method of claim 1 wherein the first namespace is an internet top-level domain and wherein the second namespace is a namespace of social media handles.

5. The method of claim 1 wherein the second namespace is an internet top-level domain and wherein the first namespace is a namespace of social media handles.

6. Apparatus comprising:
a first registry with respect to a first namespace;
a second registry with respect to a second namespace, the first and second namespaces being non-identical;
a first blocking system administered by the first registry, the first blocking system containing a first list of canonically expressed names in the first namespace, the first blocking system disposed to make use of a first concordance defined with respect to the first namespace for blocking registrations of names in the first namespace based upon the event of an output of the first concordance with respect to a name in the list in the first blocking system matching a name proposed for registration in the first namespace;
the first list being a list stored in a first server;
a second blocking system administered by the second registry, the second registry being non-identical to the first registry, the second blocking system containing a second list of canonically expressed names in the second namespace, the second blocking system disposed to make use of a second concordance defined with respect to the second namespace for blocking registrations of names in the second namespace based upon the event of an output of the second concordance with respect to a name in the list in the second blocking system matching a name proposed for registration in the second namespace;
the second list being a physical list stored in a second server;
the first server being logically separate from the second; and
a replication system disposed to periodically replicate the list of canonically expressed names in the first blocking system into the second blocking system, and further disposed to periodically replicate the list of canonically expressed names in the second blocking system into the first blocking system.

7. A method for use with a registry with respect to a namespace, the method carried out with respect to a blocking system administered by the registry, the blocking system containing a list of canonically expressed names in the namespace, the blocking system disposed to make use of a concordance defined with respect to the namespace for blocking registrations of names in the namespace based upon the event of an output of the concordance with respect to a name in the list in the blocking system matching a name proposed for registration in the namespace;
the method carried out with respect to first and second registrars communicating with the registry, the second registrar being non-identical to the first registrar;
the method carried out with respect to an item in the list of canonically expressed names in the namespace, the item associated with a customer;
the method comprising the steps of:
receiving at the second registrar a request from the customer to transfer responsibility for the item in the list of canonically expressed names in the namespace from the first registrar to the second registrar;
at the blocking system, updating the record indicative of the registrar associated with the item in the list of canonically expressed names in the namespace to indicate the second registrar; and
annunciating the update to a human user.

8. The method of claim 7 further comprising the steps of:
receiving a request for registration of a domain name in the namespace from a registrar, and
blocking the registration thereof based upon an entry in the blocking system of the registry; and
annunciating the blocking to a human user.

9. The method of claim 7 wherein each namespace is an internet top-level domain.

10. The method of claim 7 wherein the first namespace is an internet top-level domain and wherein the second namespace is a namespace of social media handles.

11. The method of claim 7 wherein the second namespace is an internet top-level domain and wherein the first namespace is a namespace of social media handles.

12. Apparatus comprising:
a registry with respect to a namespace, a blocking system administered by the registry, the blocking system containing a physical list of canonically expressed names in the namespace, the blocking system disposed to make use of a concordance defined with respect to the namespace for blocking registrations of names in the namespace based upon the event of an output of the concordance with respect to a name in the list in the blocking system matching a name proposed for registration in the namespace,
first and second registrars communicating with the registry, the second registrar being non-identical to the first registrar, the blocking system having a record indicative of a respective registrar associated with each item in the list of canonically expressed names.

13. A method for use with a registry with respect to a namespace, the method carried out with respect to a blocking system administered by the registry, the blocking system containing a list of canonically expressed names in the namespace, the blocking system disposed to make use of a concordance defined with respect to the namespace for blocking registrations of names in the namespace based upon the event of an output of the concordance with respect to a name in the list in the blocking system matching a name proposed for registration in the namespace,
the method carried out with respect to a first registrar communicating with the registry,
the method carried out with respect to an item in the list of canonically expressed names in the namespace, the item associated with a customer;
the method carried out with respect to a third party;
the method comprising the steps of:
receiving at the first registrar a request from the customer to unblock a particular variant of the item in the list of canonically expressed names in the namespace;
receiving from the first registrar an authorization code associated with the particular variant of the item in the list of canonically expressed names in the namespace, the authorization code or information indicative thereof having been stored in an unblocking database within the blocking system;
at a second registrar, receiving from the third party the authorization code or information indicative thereof, and thereby permitting the registration by the third party of a domain name corresponding to the particular variant of the item in the list of canonically expressed names in the namespace; and
annunciating the registration to a human user.

14. The method of claim 13 wherein each namespace is an internet top-level domain.

15. The method of claim 13 wherein each namespace is a namespace of social media handles.

16. Apparatus comprising:
a registry with respect to a namespace, a blocking system administered by the registry, the blocking system containing a physical list of canonically expressed names in the namespace, the blocking system disposed to make use of a concordance defined with respect to the namespace for blocking registrations of names in the namespace based upon the event of an output of the concordance with respect to a name in the list in the blocking system matching a name proposed for registration in the namespace,
an authorization code stored in the blocking system, the blocking system disposed to permit registration of a domain name associated with a particular variant of an item in the list of canonically expressed names in the namespace in response to presentation by a user of the authorization code or information indicative thereof.

17. A method for use with a registry with respect to a namespace, the method carried out with respect to a blocking system administered by the registry, the system containing a list of canonically expressed names in the namespace, the blocking system disposed to make use of a concordance defined with respect to the namespace for blocking registrations of names in the namespace based upon the event of an output of the concordance with respect to a name in the list in the blocking system matching a name proposed for registration in the namespace;
the method comprising the steps of:
at a first particular time, for each item in the list of canonically expressed names in the namespace, applying the concordance to the item and generating a first set of to-be-blocked names in the namespace;
thereafter, augmenting the concordance;
at a second particular time, the second particular time being after the augmentation of the concordance, for each item in the list of canonically expressed names in the namespace, applying the concordance to the item and generating a second set of to-be-blocked names in the namespace;
whereby the second set of to-be-blocked names in the namespace includes at least one to-be-blocked name in the namespace that was not in the first set of to-be-blocked names in the namespace;
at a third particular time, the third particular time being after the second particular time, receiving a registration request from a potential registrant to register the at least one to-be-blocked name in the namespace that was not in the first set of to-be-blocked names in the namespace, and blocking the registration thereof; and
annunciating the blocking to a human user.

18. The method of claim 17 wherein the namespace is an Internet domain name namespace.

19. The method of claim 18 wherein the concordance comprises at least Unicode confusables.

20. The method of claim 19 wherein augmenting the concordance comprises expansion of the Unicode confusables.

21. Apparatus for use with a registry operating with respect to a namespace, the registry receiving requests for registration of names in the namespace, the apparatus comprising:
a blocking system administered by the registry, the blocking system containing a list of canonically expressed names in the namespace, the blocking system disposed to make use of a concordance defined with respect to the namespace for blocking registrations of names in the namespace based upon the event of an output of the concordance with respect to a name in the list in the blocking system matching a name proposed for registration in the namespace;
the blocking system disposed from time to time to iterate through each item in the list of canonically expressed names in the namespace, applying the concordance to the item and generating a first set of to-be-blocked names in the namespace;
the blocking system further disposed to respond to an augmentation of the concordance by iterating again through each item in the list of canonically expressed names in the namespace, applying the concordance to the item and generating a second set of to-be-blocked names in the namespace, the second set of to-be-blocked names in the namespace thereby being non-identical to the first set of to-be-blocked names in the namespace;
the blocking system further disposed, in the event of receipt of a registration request from a potential registrant to register one of the to-be-blocked name in the namespace, to carry out blocking of the requested registration;
the apparatus further comprising an annunciation means for annunciating such a blocking to a human user.

22. The apparatus of claim 21 wherein the namespace is an Internet domain name namespace.

23. The apparatus of claim 22 wherein the concordance comprises at least Unicode confusables.

24. The apparatus of claim 23 wherein augmenting the concordance comprises expansion of the Unicode confusables.
